(19) United States
(12) Patent Application Publication
(10) Pub. No.: US 2014/0108804 A1
(43) Pub. Date: Apr. 17, 2014

(54) SYSTEM AND METHOD FOR VERIFYING THE AUTHENTICITY OF AN ELECTRONIC DEVICE

(71) Applicant: SLING MEDIA INC., Foster City, CA (US)

(72) Inventors: Rajesh Kanungo, Sunnyvale, CA (US); Benjamin Loomis, Campbell, CA (US)

(73) Assignee: SLING MEDIA INC., Foster City, CA (US)

(21) Appl. No.: 13/797,480

(22) Filed: Mar. 12, 2013

Related U.S. Application Data
(60) Provisional application No. 61/712,638, filed on Oct. 11, 2012.

(51) Int. Cl. H04L 9/32

(52) U.S. Cl. CPC H04L 9/3244
USPC 713/170

(57) ABSTRACT

Methods and systems are provided for verifying the authenticity of an electronic device by a security server comprising a processor and a memory. The method, for example, may include, but is not limited to, receiving, from the electronic device, a unique identifier associated with the electronic device, determining, by the processor, a public key corresponding to the unique identifier, generating, by the processor, a message, encrypting, by the processor, the message with the determined public key, transmitting, to the electronic device, the encrypted message; receiving, from the electronic device, a response message, comparing the response message to the generated message, and authorizing the electronic device based upon the comparison.

### CROSS-REFERENCES TO RELATED APPLICATIONS

This Application claims priority to U.S. Provisional Application Ser. No. 61/712,638, filed Oct. 11, 2012.

### TECHNICAL FIELD

The following relates to systems and methods for verifying the authenticity of an electronic device.

### BACKGROUND

Electronic devices are becoming increasingly prevalent in today's society. Some electronic devices utilize external resources. For example, an electronic device may exchange data with a server via an internet network, cellular or satellite connection. Accordingly, the server preferably has a secure method for verifying that the electronic device is authentic (i.e., not copied or emulated by software) in order to limit unauthentic devices from utilizing the server resources.

### SUMMARY

In accordance with one embodiment, a method for verifying the authenticity of an electronic device by a security server comprising a processor and a memory. The method may include, but is not limited to, receiving, from the electronic device, a unique identifier associated with the electronic device, determining, by the processor, a public key corresponding to the unique identifier, generating, by the processor, a message, encrypting, by the processor, the message with the determined public key, transmitting, to the electronic device, the encrypted message; receiving, from the electronic device, a response message, comparing the response message to the generated message, and authorizing the electronic device based upon the comparison.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### DESCRIPTION OF THE DRAWING FIGURES

Exemplary embodiments will hereinafter be described in conjunction with the following drawing figures, wherein like numerals denote like elements.

FIG. 1 is a block diagram of a system for verifying the authenticity of an electronic device, in accordance with an embodiment; and

FIG. 2 is a flow diagram illustrating a method for verifying the authenticity of an electronic device, in accordance with an embodiment.

### DETAILED DESCRIPTION

According to various exemplary embodiments, systems and methods for verifying the authenticity of an electronic device are provided. As discussed above, some electronic devices utilize server resources or services. In order to limit unauthentic devices from utilizing the server resources or services, the server is provided with a database including a list of each authentic electronic device. Associated with each authentic electronic device are a unique identifier and a unique public key. A private key paired with the public key is stored in a processor in the electronic device. Accordingly, the server, with the knowledge of the electronic device's unique identifier can transmit a message encoded with the public key of the processor to the electronic device. The message can only properly be decoded with the private key stored in the processor. Accordingly, if the electronic device can return the message, the server can authenticate the device, as discussed in further detail below.

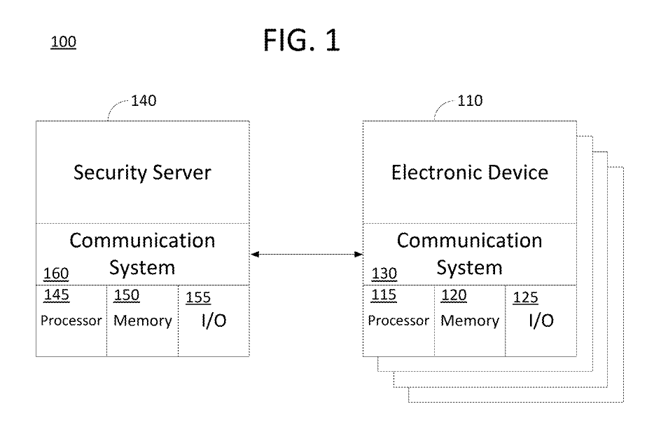

FIG. 1 is a block diagram of a system 100 for verifying the authenticity of an electronic device 110, in accordance with an embodiment. The system may include any number of electronic devices 110. In one embodiment, for example, the electronic device 110 may be a place-shifting device, such as a Slingbox. A place-shifting device is a device capable of transmitting a packetized stream of media content over network. A places-shifting device incorporates suitable transcoder logic to convert audio/video or other media data into a packetized format that can be transmitted over the network. The media data may be in any format, and may be received from any source such as a broadcast, cable or satellite television programming source, a “video-on-demand” or similar source, a digital video disk (DVD) or other removable media, a video camera, and/or the like. In other embodiments, the electronic device 110 may be a personal computer, a laptop computer, a tablet, a cellular phone, a television, a set-top-box (STB), a digital-video recorder (DVR), or any other consumer or commercial electronic device.

The electronic device 110 includes a processor 115. The processor 115 may be a central processing unit (CPU), an application specific integrated circuit (ASIC), a field programmable logic array (FPLA), programmable logic controller (PLC), a microcontroller or any other type of logic device. The processor 115 includes a unique identifier, such as a serial number. The unique identifier may be stored in a memory (not illustrated) located within the processor 115 itself. The processor 115 is also assigned a public/private key pairing. Public/private key encryption is an asymmetrical encryption system. Data encrypted with a public key can only be properly decrypted with the corresponding private key. Likewise, data encrypted with the private key can only be properly decrypted with the corresponding public key. In one embodiment, for example, the private key is stored in the memory of the processor 115. The private key is used to decrypt a message sent to the electronic device 110 which has been encrypted with the public key by a security server 140 in order to verify the authenticity of the electronic device 110, as discussed in further detail below. In another embodiment, for example, the public key may be stored in the memory. In this embodiment, for example, the public key is used to decrypt a message sent to the electronic device 110 which has been encrypted with the private key by a security server 140 in order to verify the authenticity of the electronic device 110.

The electronic device further includes a memory 120. The memory 120 may be any combination of non-volatile and volatile memories, including, but not limited to, one or more hard drives, any type of random access memory (RAM), any type of read only memory (ROM) and/or one or more computer readable memory devise (e.g., CD's, DVD's, etc.). The electronic device 110 further includes a user interface 125 allowing a user to interact with the electronic device 110. The user interface 125 will vary depending upon the type of device. In various embodiments, for example, the user interface 125 may be a display, a keyboard, a mouse, a touch screen, a remote control, electronic switches, or any other type of input device or combination thereof. The electronic device 110 also includes a communication system 130. The communication system may be an internet network interface, a cellular interface, a satellite interface, or an interface for any other type of communication network, or a combination thereof.

The system 100 further includes at least one security server 140. The security server 140 includes a processor 145. The processor 145 may be a central processing unit (CPU), an application specific integrated circuit (ASIC), field programmable logic array (FPLA), programmable logic controller (PLC), a microcontroller or any other type of logic device. The security server 140 further includes a memory 150. The memory 150 may be any combination of non-volatile and volatile memories, including, but not limited to, one or more hard drives, any type of random access memory (RAM), any type of read only memory (ROM) and/or one or more computer readable memory devise (e.g., CD's, DVD's, etc.).

The memory 150 of the security server stores a database. The database includes a list of all of the processors 115 installed in the electronic devices 110. Each processor 115 is identified with its corresponding unique identifier and is associated with either a public or private key, whichever is not stored in the memory of the processor.

The security server 140 further includes a user interface 155 allowing a user to interact with the security server 140. The user interface 155 will vary depending upon the type of device. In various embodiments, for example, the user interface 155 may be a display, a keyboard, a mouse, a touch screen, or any combination thereof. The security server 140 also includes a communication system 160. The communication system 160 may be an internet network interface, a cellular interface or an interface for any other type of communication network, or a combination thereof. The communication system 160 allows the security sever to communicate with the electronic device, via the communication system 130 of the electronic device, to verify the authenticity of the electronic device 110, as discussed in further detail below.

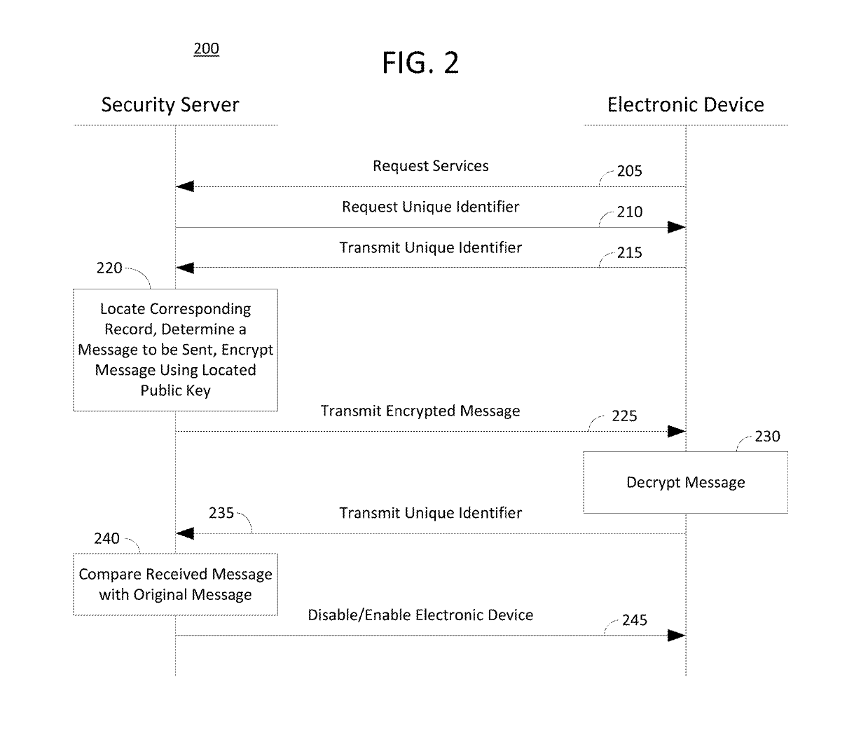

FIG. 2 is a flow diagram illustrating a method 200 for verifying the authenticity of an electronic device, in accordance with an embodiment. In one embodiment, for example, the method 200 may begin with the electronic device requests service from the security server 140. (Step 205). The electronic device 110 could request any number of different services from the security server, including, but not limited to, data services (requesting data for the electronic device 110 or requesting data be pushed to another device), or cellular services. In one embodiment, for example, the electronic device 110 may send the unique identifier associated with the electronic device 110 to the security server along with the requested service. In another embodiment, for example, the security server 140 may request the unique identifier in response to receiving the service request. (Step 210). In other embodiments, for example, the method 200 may begin with the security server requesting the unique identifier of the electronic device 110. (Step 210). The security server 140 may periodically (i.e., hourly, daily, weekly, monthly, etc.) being the method to periodically verify the authenticity of the electronic device. The electronic device 110, in response to receiving the request, transmits the unique identifier to the security server 140. (Step 215). In one embodiment, for example, the electronic device 110 may send the unique identifier via the communication system 130 over a secure shell (SSH) connection. In other embodiments, for example, the communication system 130 may utilize a hypertext transfer protocol secure (HTTPS) connection.

Upon receiving the unique identifier, the processor 145 of the security server 140 looks up the unique identifier in the database stored in the memory 150. As discussed above, each processor 115 in the system 100 is assigned a unique public/private key pair. The processor 145 then encrypts a message with the public key (if the private key is stored in the processor 115 of the electronic device) or the private key (if the public key is stored in the processor 115 of the electronic device) corresponding to the specific processor 115. (Step 220). In one embodiment, for example, the message may be a randomly created. Accordingly, even if a hacker was able to capture a message previously decrypted by the processor 115, the previously decrypted message would not be able to be retransmitted to authorize another device. In another embodiment, for example, each processor 115 may be assigned a specific message. Accordingly, if a hacker were to create an electronic device (either via hardware or emulated via software) and assign the created electronic device a valid unique identifier, the hacker would be unable to identify the message corresponding to the unique identifier in addition to not knowing the public or private key assigned to the unique identifier.

The communication system 160 of the security server then transmits the encrypted message to the electronic device 110. (Step 225). The processor 115 then decrypts the message with the public or private key stored in the processor 115. (Step 230). The processor 115 preferably handles the entire decryption process within the processor itself In other words, the processor preferably uses an internal unreadable memory when performing the calculation rather than the memory 120 of the electronic device 110. Accordingly, since the processor 115 handles the decryption entirely within the processor itself, the public or private key stored in the processor should remain undetectable.

The processor 115 then causes the communication system 130 of the electronic device 110 to transmit the decrypted message to the security server 140. (Step 235). The processor 145 of the security server 140 then compares the received message with the transmitted message. (Step 240). If the messages match, the processor 145 then authorizes the electronic device. (Step 245). In one embodiment, for example, authorizing the electronic device 110 allows the electronic device 110 to use the other services of the security server 140, as discussed above. If the messages do not match, the server does not authorize the electronic device or deauthorizes a previously authorized electronic device 110. (Step 245). In one embodiment, for example, the unauthorized electronic device 110 would be prohibited from using the services of the security server 140 or another server within the system 100. In another embodiment, for example, the security server 140 may transmit a disabling signal to the electronic device, disabling some or all of the features of the electronic device 110.

The term “exemplary” is used herein to represent one example, instance or illustration that may have any number of alternates. Any implementation described herein as “exemplary” should not necessarily be construed as preferred or advantageous over other implementations.

Although several exemplary embodiments have been presented in the foregoing description, it should be appreciated that a vast number of alternate but equivalent variations exist, and the examples presented herein are not intended to limit the scope, applicability, or configuration of the invention in any way. To the contrary, various changes may be made in the function and arrangement of the various features described herein without departing from the scope of the claims and their legal equivalents.

What is claimed is:

1. A method for verifying the authenticity of an electronic device by a security server comprising a processor, the method comprising:
receiving, from the electronic device, a unique identifier associated with the electronic device;
determining, by the processor, a public key corresponding to the unique identifier;
generating, by the processor, a message;
encrypting, by the processor, the message with the determined public key;
transmitting, to the electronic device, the encrypted message;
receiving, from the electronic device, a response message to the encrypted message;
comparing the response message to the generated message; and
authorizing the electronic device based upon the comparison.

2. The method of claim 1, further comprising periodically transmitting to the electronic device a request for the unique identifier associated with the electronic device.

3. The method of claim 1, authorizing the electronic device to utilize a server based service when response message to the encrypted message matches the generated message.

4. The method of claim 1, further comprising deauthorizing the electronic device to utilize a server based service when the response message to the encrypted message does not match the generated message.

5. The method of claim 1, wherein the authorizing further comprises transmitting, to the electronic device, a message to enable the electronic device when the response message to the encrypted message matches the generated message.

6. The method of claim 1, wherein the authorizing further comprises transmitting, to the electronic device, a message to disable the electronic device when the response message to the encrypted message does not match the generated message.

7. The method of claim 1, further comprising:
receiving, from the electronic device, a request to utilize a server based service; and
transmitting, in response to the request to utilize the server based service, a request to the electronic device for the unique identifier associated with the electronic device.

8. The method of claim 1, wherein the unique identifier associated with the electronic device is received with a request from the electronic device to utilize a server based service.

9. The method of claim 1, wherein the message is randomly generated.

10. A security server, comprising:
a memory configured to store a database identifying a plurality of electronic devices based upon a unique identifier associated with each electronic device and a public key associated with each electronic device;
a communication system; and
a processor communicatively coupled to the communication system and the memory, wherein the processor is configured to:
receive, from the communication system, the unique identifier associated with one of the plurality of electronic devices;
determine the public key corresponding to the unique identifier;
generate a message;
encrypting the message with the determined public key;
transmit the encrypted message to the respective electronic device via the communication system;
receive, from the communication system, a response message to the encrypted message;
compare the response message to the generated message; and
authorize the electronic device based upon the comparison.

11. The security server of claim 10, wherein the processor is further configured to periodically transmit, via the communication system, to the electronic device a request for the unique identifier associated with the electronic device.

12. The security server of claim 10, wherein the processor is further configured to authorize the electronic device to utilize a server based service when response message to the encrypted message matches the generated message.

13. The security server of claim 10, wherein the processor is further configured to deauthorize the electronic device to utilize a server based service when the response message to the encrypted message does not match the generated message.

14. The security server of claim 10, wherein the processor is further configured to transmit, to the electronic device via the communication system, a message to enable the electronic device when the response message to the encrypted message matches the generated message.

15. The security server of claim 10, wherein the processor is further configured to transmit, to the electronic device via the communication system, a message to disable the electronic device when the response message to the encrypted message does not match the generated message.

16. The security server of claim 10, wherein the processor is further configured to:
receive, from the communication system, a request to utilize a server based service from one of the plurality of electronic devices; and
transmit, in response to the request to utilize the server based service, a request to the electronic device for the unique identifier associated with the electronic device via the communication system.

17. The security server of claim 10, wherein the unique identifier associated with the one of the plurality electronic devices is received with a request from the respective electronic device to utilize a server based service.

18. The security server of claim 10, wherein the message is randomly generated by the processor.

19. The security server of claim 10, wherein the electronic device is a place shifting device.

20. The security server of claim 10, wherein the communication system is an internet interface.
